(19) United States
(12) Patent Application Publication
(10) Pub. No.: US 2012/0272810 A1
(43) Pub. Date: Nov. 1, 2012

(54) Add-On Leg Bracket For A Suspended Tom-Tom

(76) Inventor: Mark Alfred Calabrese, South Yarmouth, MA (US)

(21) Appl. No.: 13/460,490

(22) Filed: Apr. 30, 2012

Related U.S. Application Data
(60) Provisional application No. 61/480,954, filed on Apr. 29, 2011.

(51) Int. Cl. G10D 13/02

(52) U.S. Cl. 84/421

(57) ABSTRACT

An add-on leg bracket for a suspended tom-tom prevents tom-tom from bouncing. The bracket consists of a main component that anchors the support leg, and two slotted arms that secure the bracket to the tom-tom. The face of the main component presents three openings: one centrally positioned opening leads to a conduit that receives the support leg; two openings positioned equidistantly from the central opening are threaded to accommodate screws that fasten the arms of the bracket to the main component. The outward facing side of the main component has a threaded opening that runs perpendicular to and pierces the support leg conduit. It receives a thumb screw fastening the support leg to the bracket. The arms are slotted with a closed track to accommodate thumb screws securing the arm to the main component and notched at one end to lock around tension lug on the tom-tom.

### REFERENCE TO RELATED APPLICATIONS

This patent application claims the benefit of U.S. Provisional Application No. 61,480,954 filed on Apr. 29, 2011, the disclosure of which is incorporated herein by reference in its entirety.

### BACKGROUND OF THE INVENTION

1. Field of the Invention

The present invention relates to an add-on support leg bracket for a suspended tom-tom that prevents the tom-tom from bouncing.

2. Description of Related Art

The field related to the invention comprises a number of tom-tom cymbal-like stands for free-standing tom-toms. The art also includes a range of holders for suspended tom-toms that are typically mounted onto a base drum, with a variation on the latter group consisting of suspended tom-tom holders that make adjustment of tom-tom angle possible. Moreover, a leg system for a drum that is traditionally strapped to the player for marching such as a Brazilian Surdo is disclosed in U.S. Pat. Appl. No. US 2008/0116332 A1 to van der Meullen at al., and a bracket for mounting drums that reduces vibrations is described in U.S. Pat. No. 4,158,980 to Gauger.

The stand of the van der Meullen invention is designed to be mounted to the drum when played while stationary. It ensures proper drum distance from the floor and allows drum positioning so it can be played either vertically or horizontally. The leg system of this invention has to be used in multiples to be functional. The support element hooks and clamps onto one drum lug and needs to be tightened into position with a wing nut or equivalent. It is also too large to fit in the space between the bottom rim that tightens the drum head and the tension lug housing of a conventional modern drum. Consequently, the support element cannot grasp the leading edge of the drum and does not provide solution to the problem of drum bouncing while in a substantially suspended position.

The Gauger patent claims a bracket that is essentially semi-circular or larger and affixed to a drum though at least three fixation points, i.e., through two substantially diametrically opposed lugs of a drum and at least one intermediate lug. The bracket is outfitted with flanges having openings in them spaced and sized so that drum lugs can be threaded through them. Since it is mounted on a traditional fixed support, this invention is an intermediary holder that is designed to bear the full weight of a suspended drum. Rubber grommets in the bracket openings serve to reduce vibrations at the drum lugs which are the portions of the drum where vibration is relatively minimal.

None of the hitherto described holders provides means to substantially stop a suspended drum up and down movement when played. Therefore, a need exists for a bracing system that prevents a suspended drum from bouncing.

### SUMMARY OF THE INVENTION

In an exemplary embodiment of the present invention, there is disclosed an add-on leg bracket for a suspended tom-tom that prevents tom-tom from bouncing. Present invention provides a mechanism for leg member attachment to the drum that is unlike other such systems seen in the prior art. It does not clamp on a drum lug but slides in to latch onto two adjacent drum tension lugs fixing the bracket in place without additional fastening mechanisms. The bracket consists of a main component that anchors the support leg, two slotted arms that secure the bracket to the leading edge of a suspended drum the drum and three screws or other fastening elements.

The face of the main component presents three openings, and the outward facing edge has one. The centrally positioned opening on the face of the main component leads to a conduit serving to receive the support leg. A fastening element when inserted in the side opening and tightened holds the support leg in position. Two threaded openings on the face of the main component positioned equidistantly from the central opening receive fastening elements that affix the arms of the bracket to the main component. The outward facing side of the main component has a threaded opening that runs perpendicular to and pierces the support leg conduit. It receives a fastening element which locks the support leg in the bracket. Bracket arms are notched at one end to lock around tension lug on the tom-tom and slotted with a centrally positioned closed track to receive one fastening element each.

The main component and the arms of the bracket can be manufactured from aluminum stock or any other resilient material according to standard manufacturing procedures in the art. To assemble the instant invention the arms of the bracket are affixed to the main component so that the notched ends of the arms face opposite directions. Subsequently, the notched ends of bracket arms can turn slide into place between two adjacent tension lugs on the drum. The support leg is inserted in the central opening and fastened to the bracket with a fastening element. All the bracket components are necessary and none is optional for the unit to work for the intended purpose. However, there is no need for additional fastening elements and drilling holes in the drum shell to affix the bracket to the drum. The installation can be done on the fly. When assembled and installed as herein described the instant invention prevents the suspended drum from bouncing.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting. It is important, therefore, that the claims be regarded as including equivalent constructions insofar as they do not depart from the spirit and scope of the present invention.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a top view of the bracket main component.

FIG. 2 is a side view of the bracket main component.

FIG. 3 is a top view of the arm of the bracket.

FIG. 4 is a side view of the arm of the bracket.

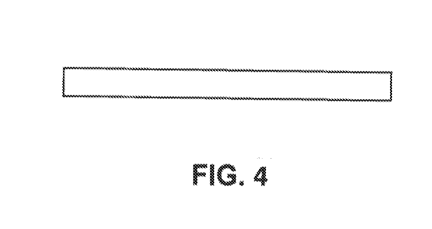

FIG. 5 is a perspective view of the assembled bracket installed on a suspended drum.

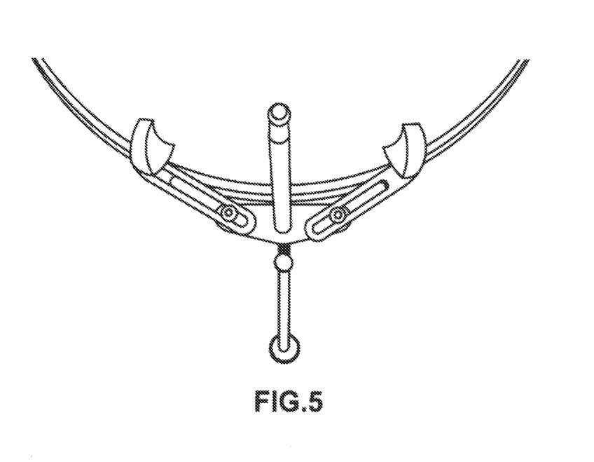

### DESCRIPTION OF THE PREFERRED EMBODIMENT

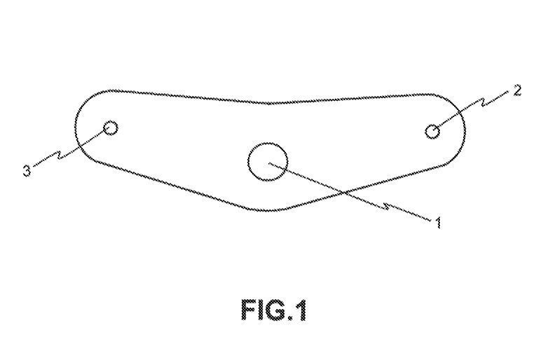

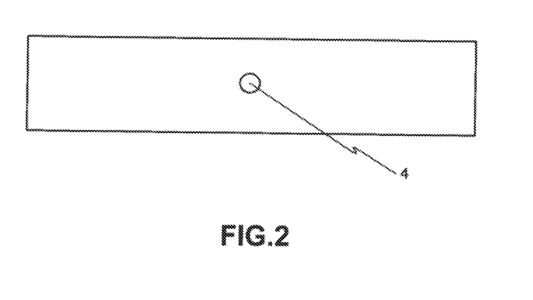

Referring to FIG. 1, there is disclosed a 3½″ long, 1½″ wide (FIG. 1), and ½ thick [FIG. 2]. The face of the main component presents three openings (FIG. 1), and the outward facing edge has one (FIG. 2). One centrally positioned opening 13/32″ in diameter [1] on the face of the main component leads to a conduit serving to receive the support leg. Its center is ½ inch from the outward facing edge to allow #¼-20 thumb screw, when inserted in the side opening, to secure the support leg in position. Two 10-20 openings [2, 3] on the face of the main component are positioned equidistantly from the central opening, and are threaded to receive thumb screws that affix the arms of the bracket to the main component. The outward facing side of the main component (FIG. 2) has a threaded opening [4] that runs perpendicular to and pierces the support leg conduit. It receives a #⅓-20 thumb screw fastening the support leg to the bracket. All the bracket components are necessary and none is optional for the unit to work for the intended purpose.

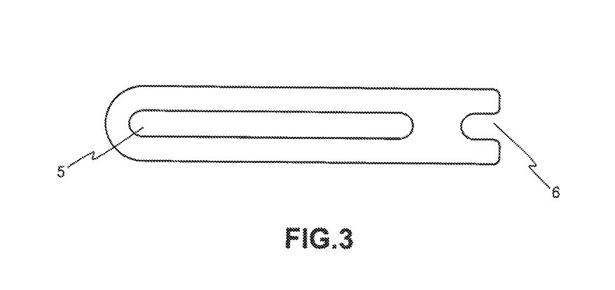

Bracket arms are 3″ long, ½″ wide and ⅛ ″ thick (FIG. 3). The arms are slotted with a centrally positioned 10-20 diameter closed track [5] to receive one #10-20 thumb screw each. The screws affix the arm to the main component. The arms are notched at one end [6] to lock around a tension lug on the tom-tom.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A suspended drum add-on support leg bracket that prevents said drum from bouncing, comprising:
a main component that
on the face of said component presents with: a central opening leading to a support element conduit that receives a support element; two openings positioned equidistantly from said central opening on opposite ends of said main component serving to receive fastening elements;
on the outward-facing edge presents with: an opening that leads to and penetrates said support element conduit that allows fastening element to affix support element within said support conduit;
two arms notched at one end for each to log around one of two adjacent tension lugs on a drum, and slotted with a closed track along said arm body to receive fastening elements that affix said arms to said main component;
two fastening elements that affix said arms to said main component;
one fastening element that secures support element within said main component.

2. A suspended drum add-on support leg bracket of claim 1 where said main component and said bracket arms are made from aluminum stock.

3. A suspended drum add-on support leg bracket of claim 1 where said fastening elements are thumb screws.

4. A suspended drum add-on support leg bracket of claim 1 where said fastening elements are wing nuts.

5. A suspended tom-tom add-on support leg bracket, that prevents said tom-tom from bouncing, comprising:
a main component that
on the face of said component presents with: a central opening leading to a support conduit that receives a support element;
two openings positioned equidistantly from said central opening on opposite ends of said main component serving to receive fastening elements;
on the outward-facing edge presents with: an opening that leads to and penetrates said support element conduit that allows fastening element to affix a support element within said support conduit; and
two arms notched at one end for each to log around one of two adjacent tension lugs on a tom-tom, and slotted with a closed track along said arm body to receive fastening element that affix said arms to said main component;
two fastening elements that affix said arms to said main component;
one fastening element that secures support element within said main component.

6. A suspended tom-tom add-on support leg bracket of claim 5 where said main component and said bracket arms are made from aluminum stock.

7. A suspended tom-tom add-on support leg bracket of claim 5 where said fastening elements are thumb screws.

8. A suspended tom-tom add-on support leg bracket of claim 5 where said fastening elements are wing nuts.
